(19) United States
(12) Patent Application Publication
(10) Pub. No.: US 2011/0317202 A1
(43) Pub. Date: Dec. 29, 2011

(54) IMAGE FORMING APPARATUS, CONTROL METHOD THEREOF, AND STORAGE MEDIUM

(75) Inventor: Akira Negishi, San Mateo, CA (US)

(73) Assignee: CANON KABUSHIKI KAISHA, Tokyo (JP)

(21) Appl. No.: 13/165,559

(22) Filed: Jun. 21, 2011

(30) Foreign Application Priority Data
Jun. 29, 2010 (JP) 2010-148203

(51) Int. Cl. G06K 15/02

(52) U.S. Cl. 358/1.14

(57) ABSTRACT

An image forming apparatus to execute, during processing of a job to be interrupted that is currently being processed, interrupt print processing for starting processing on an interrupting job for which an interrupt instruction is issued based on an interrupt printing instruction, the image forming apparatus includes a generation unit configured to generate image data by performing RIP processing on a print job including at least one page, a printing unit configured to perform print processing based on image data generated by the generation unit, and a control unit configured to, when the RIP processing of the pages included in the interrupting job by the generation unit is finished, control the printing unit so as to stop the print processing on the job to be interrupted and start print processing of the interrupting job.

### BACKGROUND OF THE INVENTION

1. Field of the Invention

The present invention relates to an image forming apparatus having an interrupt function for interrupting a print job being processed with another print job, a control method for the image forming apparatus, and a storage medium.

2. Description of the Related Art

Conventionally, in the commercial printing industry, it is still standard to use a large-scale printing apparatus, such as an offset type printing machine. In this industry, a printing company receives a production request for a print product (e.g., a magazine, newspaper, catalog, advertisement, a photo magazine etc.) from a third party (customer, client), produces the print product desired by the client, delivers the print product to the client, and then is compensated from the client.

In the printing industry, the work is performed through a series of steps, such as input, design and layout, comprehensive layout (presentation based on printer output), correction (layout correction and color correction), proofing (preview printing), block copy preparation, printing, post-processing finishing, and dispatch.

The reason for this is that preparation of a block copy is essential in order to utilize an offset type printing machine, and that once the block copy is produced, it is not easily corrected. Further, because such correction is expensive, careful proofreading, specifically, checking of the layout and colors was essential.

Thus, in this sort of industry, a large-scale apparatus has been necessary. Furthermore, a certain amount of time has been required to produce the print product desired by the client. In addition, specialist knowledge is required for each of these operations, and the know-how of an expert called an “artisan” has been necessary.

However, with the recent increases in speed and improvements in quality of electrophotographic and inkjet system printing apparatuses, a print-on-demand (hereinafter, “POD”) market has started to appear in competition with the printing industry. POD is targeted at the quick delivery system of relatively smaller-sized job lots than those handled by printing apparatuses, without the use of a large-scale apparatus or system.

Consequently, instead of the above-described large-scale printing machines and printing methods, for example, digital printing using electronic data has been realized by making maximum use of a digital image forming apparatus, such as a digital copying machine and a digital multifunction peripheral. In the POD market, digitization has progressed more than in the conventional printing industry, and management and control utilizing computers has become pervasive. Consequently, due to the use of computers, the POD market is approaching the level of the printing industry to a certain extent.

In view of such a background, within the POD market, “print for pay” (PFP) has developed as a printing service performed by copy/print shops. In addition, some companies have set up a centralized reproduction department (CRD) as a printing service for internal company operations.

Advantages of PFP and CRD include a lower cost than offset printing, as well as shorter delivery time. Consequently, in the POD market, how to reduce printing apparatus downtime and increase printing productivity is a serious issue.

In the POD market, an operator usually successively processes (prints) the jobs received from customers. In such an environment, when a rush job is received, the operator may wish to stop the job that he/she is currently working on, and print the rush job (interrupt printing). In interrupt printing too, productivity is emphasized.

Japanese Patent Application Laid-Open No. 2001-246811 discusses an example of interrupt printing. However, this example only allows interrupt printing between printing units. Thus, there is still a need for improvement in terms of total printing productivity.

In interrupt printing, normally, a job currently being printed (hereinafter, sometimes referred to as “job to be interrupted” or “interrupted job”) is first temporarily stopped at an interruption timing that may even be in the middle of the job, and a specified job (hereinafter, referred to as “interrupting job”) is printed. Then, after the printing of the interrupting job has finished, the remaining portion of the original interrupted job is printed.

However, if the interrupting job has a large number of pages and requires a long time for the Raster Image Processor (RIP) processing of each page, cycle down may occur during the printing of the interrupting job due to the RIP processing of the heavy pages, which can result in a deterioration in the total printing throughput. Especially, if the interrupted job can be printed at engine speed, for example if the RIP processing of the interrupted job has finished or if the interrupted job is a variable data print (VDP) job, the affect on total printing throughput is substantial.

### SUMMARY OF THE INVENTION

According to an aspect of the present invention, an image forming apparatus to execute, during processing of a job to be interrupted that is currently being processed, interrupt print processing for starting processing on an interrupting job for which an interrupt instruction is issued based on an interrupt printing instruction, the image forming apparatus includes a generation unit configured to generate image data by performing RIP processing on a print job including at least one page, a printing unit configured to perform print processing based on image data generated by the generation unit, and a control unit configured to, when the RIP processing of the pages included in the interrupting job by the generation unit is finished, control the printing unit so as to stop the print processing on the job to be interrupted and start print processing of the interrupting job.

In the present invention, based on the status of an interrupted job and an interrupting job, interrupt printing can be performed while avoiding a drop in the total printing productivity as much as possible, by controlling when to stop the printing of the interrupted job and when to start the printing of the interrupting job.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a Multi Function Peripheral (MFP) in detail according to an exemplary embodiment of the present invention.

FIG. 2 is a block diagram of an MFP control unit.

FIG. 3 is a cross-sectional diagram of an MFP (4D color system).

FIG. 4 is a block diagram of a RIP unit.

FIG. 5 is a block diagram of an output image processing unit (color system).

FIG. 6 is a schematic diagram of an operation unit.

FIG. 7 is a schematic diagram of a key input unit.

FIG. 8 is a schematic diagram of a touch panel unit.

FIG. 9 illustrates an example of a job status screen.

FIG. 10 illustrates an example of a job status screen.

FIG. 11 is a time chart of conventional interrupt print processing.

FIG. 12 is a time chart of conventional interrupt print processing.

FIG. 13 is a time chart of interrupt print processing according to a first exemplary embodiment.

FIG. 14 is a flow chart of interrupt print processing according to the first exemplary embodiment.

FIG. 15 is a time chart of interrupt print processing according to a second exemplary embodiment.

FIG. 16 is a flow chart of interrupt print processing according to the second exemplary embodiment.

FIG. 17 is a correspondence table of the interrupt print processing that is performed based on the interrupted job type and the interrupting job type.

FIG. 18 is a flowchart of interrupt print processing that is switched based on the job type.

### DESCRIPTION OF THE EMBODIMENTS

Various exemplary embodiments, features, and aspects of the invention will be described in detail below with reference to the drawings.

### <MFP Configuration>

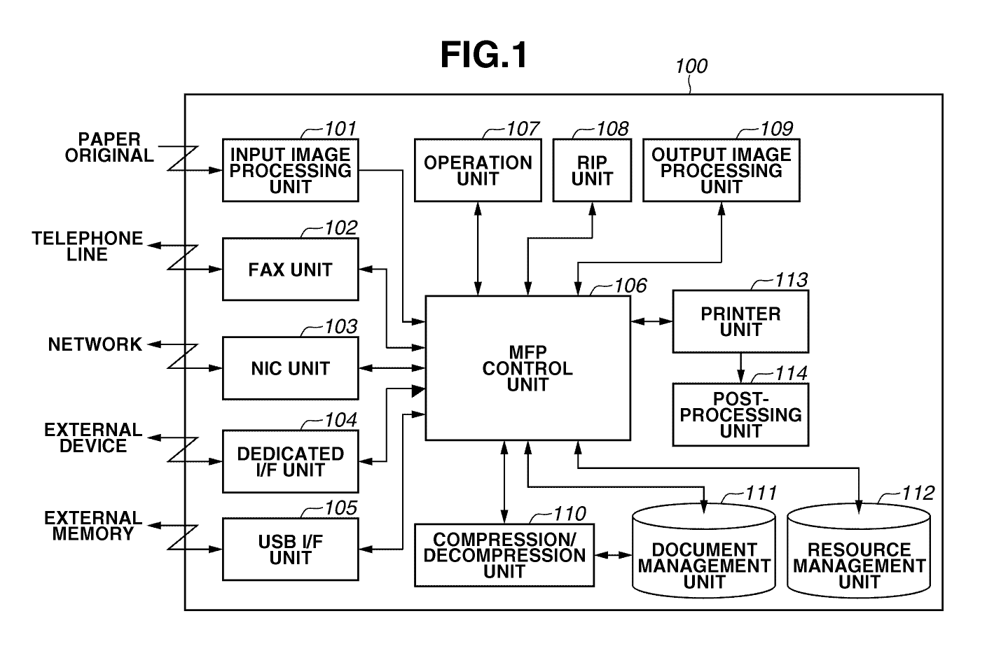

FIG. 1 is a block diagram illustrating a multifunction peripheral (MFP) 100 in detail, which is an image forming apparatus applied in the present exemplary embodiment.

The MFP 100 is an image forming apparatus that includes a memory, such as a hard disk, capable of storing a plurality of job data. The MFP 100 has a plurality of functions, such as a copying function that enables a printer unit to print job data output from a scanner via the memory, and a printing function that enables the printer unit to print job data output from an external apparatus, such as a computer, via the memory.

Broadly speaking, MFPs can be classified into full-color devices and monochrome devices. In many cases, excluding color processing and internal data, a full-color device will include the structure of a monochrome device in its basic configuration. Therefore, the present exemplary embodiment will mainly be described based on a full color device, with a description about a monochrome device added as necessary.

As described above, the configuration of the present system will be described as a multifunction type image forming apparatus that has a plurality of functions. In addition, the present system may have a configuration that includes a single function printer (SFP), which only has a printing function. Alternatively, the system may have a configuration that only includes an image forming apparatus of either type. Regardless of the type of image forming apparatus, the system may include a plurality of image forming apparatuses. Further, the present system may be configured in any manner, as long as the control according to the present exemplary embodiment can be realized.

As illustrated in FIG. 1, the MFP 100 includes an input image processing unit 101, which reads an image of a paper original or the like, and processes the read image data. Further, the MFP 100 includes a facsimile (FAX) unit 102, represented by a facsimile machine or the like, which sends/receives an image using a telephone line. The MFP 100 also includes a network interface card (NIC) unit 103, which exchanges image data and apparatus information using a network.

In addition, the MFP 100 includes a dedicated interface unit 104, which exchanges information such as image data with an external device. The MFP 100 also includes a universal serial bus (USB) interface (I/F) unit 105, which exchanges image data with a USB device, represented by a USB memory (a kind of removable media). Further, the MFP 100 includes an MFP control unit 106, which performs traffic control tasks, such as temporary storage of image data based on the MFP application and path determination.

A document management unit 111 includes a memory, such as a hard disk capable of storing a plurality of image data. The control units (e.g., the central processing unit (CPU) of the MFP control unit 106) in the image forming apparatus serve as the main units executing controls that enable a plurality of various types of image data to be stored in the hard disk.

The MFP control unit 106 can appropriately read the image data stored in the document management unit 111, transfer the read image data to an output unit such as a printer unit 113, and execute output processing, such as print processing, by the printer unit 113. Examples of the various types of data include image data from the input image processing unit 101, and facsimile job image data input via the FAX unit 102.

Further examples include image data input from an external apparatus, such as a computer, via the NIC unit 103, and various image data input via the dedicated I/F unit 104 or the USB I/F unit 105. Based on an instruction from the operator, the image data read from the hard disk can be transferred to an external apparatus, such as a computer or another image forming apparatus.

When storing image data in the document management unit 111, a compression/decompression unit 110 optionally compresses and stores the image data. The compression/decompression unit 110 decompresses the compressed stored image data back into the original image data during reading. If the data is transferred via a network, the use of compressed data, such as joint photographic experts group (JPEG), joint bi-level image experts group (JBIG), or ZIP is commonly known. After the data has been input into the MFP 100, the data is decompressed by the compression/decompression unit 110.

A resource management unit 112 stores various parameter tables that are commonly handled, such as font, color profile, and gamma tables. As well as calling up these tables as required, the resource management unit 112 can store, correct, and update the tables.

A RIP unit 108 performs RIP processing on page description language (PDL) data. When PDL data is input, the MFP control unit 106 controls the RIP unit 108 to perform RIP processing. An output image processing unit 109 optionally performs image processing for printing on the image to be printed based on the control by the MFP control unit 106.

The document management unit 111 optionally re-stores intermediate data and print-ready data (bitmap data and compressed bit map data for printing) generated at this stage. This data is then sent to the printer unit 113 that performs image formation. The sheets printed out by the printer unit 113 are fed to a post-processing unit 114, which sorts and finishes the sheets.

The MFP control unit 106 has the role of making the jobs flow smoothly. Based on how the MFP 100 is used, the MFP control unit 106 switches paths as follows. However, while it is commonly known to optionally store image data as intermediate data, the following description will only describe only the accesses by the document management unit 111 as the start point and the end point.

The processing performed by the optionally-used compression/decompression unit 110 and the post-processing unit 114, or by the MFP control unit 106 serving as an overall core of the apparatus, will be omitted, and the general flow of the processing will be described in an easy to understand manner.

Copying machine function: Input image processing unit→Output image processing unit→Printer unit
FAX sending function: Input image processing unit→FAX unit
FAX reception function: FAX unit→Output image processing unit→Printer unit
Network scan: Input image processing unit→NIC unit
Network print: NIC unit→RIP unit→Output image processing unit→Printer unit
Scan to external apparatus: Input image processing unit→Dedicated I/F unit
Print from external apparatus: Dedicated I/F unit→Output image processing unit→Printer unit
Scan to external memory: Input image processing unit→USB I/F unit
Print from external memory: USB I/F unit→RIP unit→Output image processing unit→Printer unit
Box scan function: Input image processing unit→Output image processing unit→Document management unit
Box print function: Document management unit→Printer unit
Box reception function: NIC unit→RIP unit→Output image processing unit→Document management unit
Box sending function: Document management unit→NIC unit
Preview function: Document management unit→Operation unit

In addition to the above functions, further examples include an E-mail service and a Web server function, as well as combinations of various functions. However, a description thereof will be omitted here.

Box scan, box print, box reception, or box sending are processing functions performed by the MFP in conjunction with the reading and writing of data using the document management unit 111. These functions are performed by dividing the memory in the document management unit 111 on a per-job or a per-user basis, temporarily storing the data in the memory, and inputting or outputting with a user ID or password.

An operation unit 107 is for selecting the various flows and functions described above, and for issuing an operation instruction. Further, with the increasing resolution of the display devices used in the operation unit 107, the operation unit 107 can also be used for previewing the image data in the document management unit 111, and if the image data is confirmed to be acceptable, printing the image data.

### <MFP Control Unit>

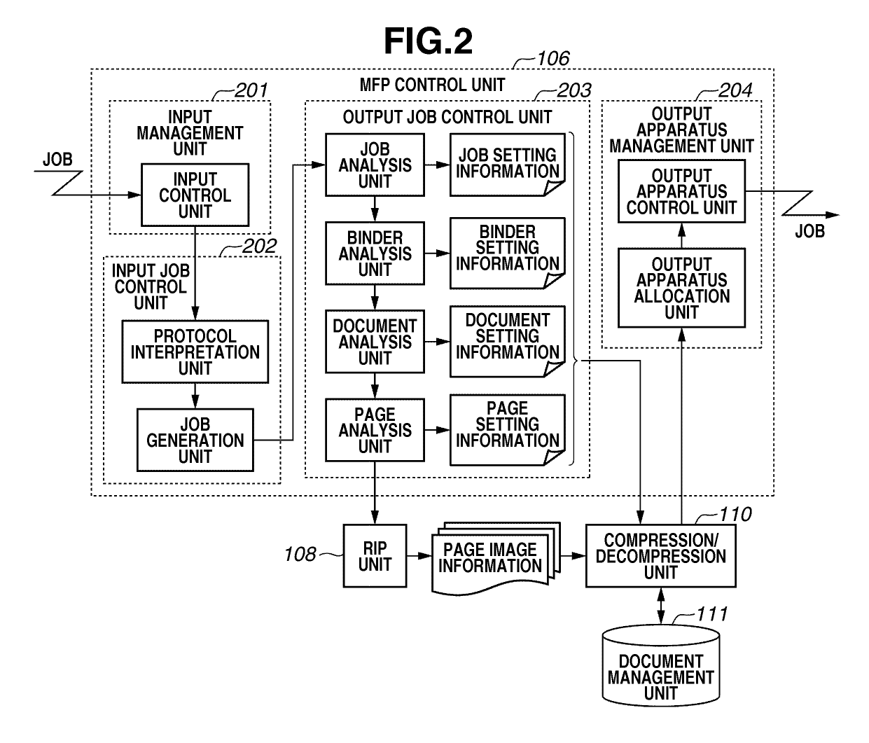

Next, referring to FIG. 2, which is a block diagram of the MFP control unit 106, the MFP control unit 106 is described.

FIG. 2 includes four sections when broadly divided. Specifically, FIG. 2 illustrates an input management unit 201 for managing input signals, an input job control unit 202 for interpreting an input job, an output job control unit 203 for organizing job setting information, and an output apparatus management unit 204 for assigning an output apparatus.

The input management unit 201 has a function of organizing the input signals from the respective interfaces in FIG. 1, and determining a switching order. For this purpose, the input management unit 201 includes an input control unit. Examples of the input signals sent via the respective interfaces include a scan image signal of a paper original and a signal input from outside of the MFP 100, such as PDL data from a network. Further examples include re-printing of the image data that was stored in the document management unit 111, and signals internally processed in the MFP 100 that links the RIP unit 108 and the output image processing unit 109.

The input job control unit 202 includes a protocol interpretation unit and a job generation unit. A series of operation requests sent from the input control unit is received as a command signal called a protocol. The protocol interpretation unit interprets the outline of the operation requests, and converts the operation requests into an operation procedure that can be understood in the MFP 100.

The job generation unit generates various jobs, such as a print job, a scan job, a PDL rasterization job, and a facsimile reception job. Various scenarios are defined for the generated jobs, such as what kind of processing they will be subjected to in the MFP 100, and where they are to be sent. Based on these scenarios, the generated jobs flow through the MFP 100.

In the output job control unit 203, job setting information (i.e., a job ticket) and image information are produced by a job analysis unit, a binder analysis unit, a document analysis unit, and a page analysis unit. In the job analysis unit, setting information concerning the whole job, such as the name of the document to be printed, the number of print copies, the destination discharge tray, and the binder order of a job including a plurality of binders, is analyzed in detail.

In the binder analysis unit, setting information concerning the overall binding, such as the bookbinding method setting, the position of staples, and the document order of a binder including a plurality of documents, is analyzed in detail. In the document analysis unit, setting information concerning the whole document, such as the page numbers of a document having a plurality of pages, a two-sided printing setting, and addition of a cover sheet or an interleaf, is analyzed in detail.

In the page analysis unit, setting information concerning the various settings for the whole page, such as the image resolution, and image direction (landscape/portrait), are analyzed in detail. Further, when PDL data is input, the page analysis unit calls the RIP unit 108 and performs RIP processing on the PDL data.

The page image information is generated based on RIP processing by the RIP unit 108. The generated page image information is compressed by the compression/decompression unit 110, then associated with the setting information, and stored in the document management unit 111.

The output apparatus management unit 204 includes an output apparatus allocation unit and an output apparatus control unit. The image information stored in the document management unit 111 is decompressed by the compression/decompression unit 110 and read along with its associated setting information. Then, the setting information and the image information are paired, and sent to the output apparatus management unit 204.

The output apparatus allocation unit has the function of arbitrating conflicts among the output apparatuses, which occur if a plurality of jobs are simultaneously processed when assigning output apparatuses based on the respective defined job scenarios. The output apparatus control unit schedules which output apparatus, such as the printer unit 113 or the post-processing unit 114, is used.

### <MFP Hardware Configuration>

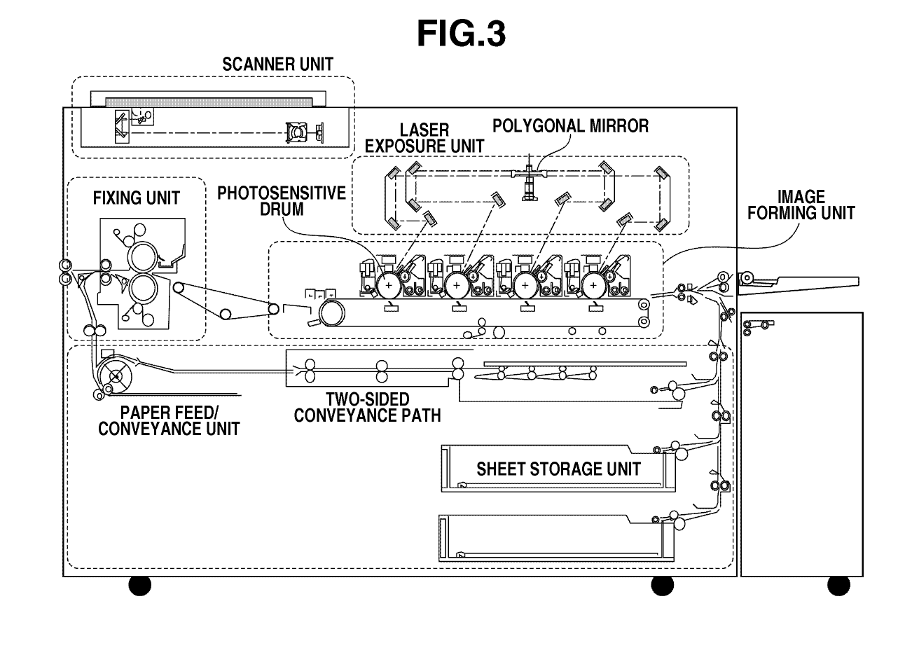

Next, the hardware configuration of the MFP 100 will be described referring to the cross-sectional diagram illustrated in FIG. 3. The MFP 100 includes a scanner unit, a laser exposure unit, photosensitive drums, an image forming unit, a fixing unit, a paper feed/conveyance unit, and a printer control unit (not-illustrated), which controls these units.

The scanner unit illuminates an original placed on a platen, optically reads the original image, and converts the image into an electrical signal to create image data. The laser exposure unit emits a light beam such as laser light modulated based on the image data onto a rotary polygonal mirror which rotates at a constant angular velocity. Then, the laser exposure unit irradiates the photosensitive drums with the light beam as reflected scanning light.

The image forming unit is realized by configuring four developing units (developing stations) in series, each of which executes a series of electrophotographic processes. More specifically, each developing unit drives and rotates a photosensitive drum, charges the photosensitive drum using a charger, and develops a latent image formed on the photosensitive drum by the laser exposure unit with a toner. Then, the developing unit transfers the toner image onto a sheet, and recovers the small amount of toner which has not been transferred and remains on the photosensitive drum.

The series of four developing units are arranged in order of cyan (C), magenta (M), yellow (Y), and black (K). After a predetermined period has elapsed from the start of forming the image for the cyan station, the image-forming operation is successively executed for magenta, yellow, and black. Based on this timing control, a full color image free from color misregistration is transferred onto the sheet.

The fixing unit is configured of a combination of rollers and belts. The fixing unit incorporates a heat source such as a halogen heater, and fuses, and fixes by heat and pressure the toner on the sheet on which the toner image has been transferred by the image forming unit.

The paper feed/conveyance unit has at least one sheet storage unit, represented by a sheet cassette or a paper deck. The paper feed/conveyance unit separates one of the sheets stored in the sheet storage unit from the rest based on an instruction from the printer control unit, and conveys the sheet to the image forming unit and the fixing unit.

The sheet is conveyed to the developing stations, where a toner image for each color is transferred onto the sheet, so that a full color toner image is finally formed on the sheet. When forming an image on both sides of the sheet, after passing through the fixing unit once, the sheet is again passed along the conveyance path for conveyance to the fixing unit.

The printer control unit communicates with the MFP control unit which controls the whole MFP, and executes control based on an instruction from the MFP control unit. Also, while managing the statuses of the scanner unit, the laser exposure unit, the image forming unit, the fixing unit, and the sheet feed/conveyance unit, the printer control unit issues instructions to keep the whole system operating smoothly.

After passing through the fixing unit, the sheet travels past an image reading sensor unit located on the conveyance path, and the printed image data is read by the image reading sensor unit. The read image data is used to check the density measurement of the output image or whether there are any abnormalities in the output image.

### <RIP Unit>

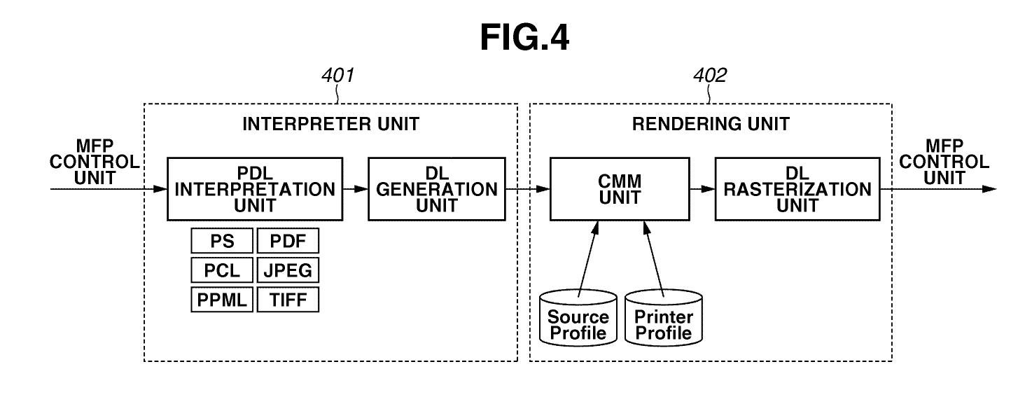

Next, the configuration of the RIP unit 108 will be described referring to FIG. 4, which is a block diagram of the RIP unit 108. A RIP is a processor which rasterizes various object information into a bitmap (raster image) in the memory. Examples of the various object information include vector information such as characters, graphics, and drawings described in a PDL, or image scanning-line information about color, pattern, a photograph and the like. Originally, RIPs were mounted in the output apparatus side as hardware. However, currently, due to increases in CPU speed, the RIP can be realized by software.

The RIP unit 108 includes two sections, an interpreter unit 401 and a rendering unit 402. The interpreter unit includes a PDL interpretation unit which performs PDL interpretation and a display list (DL) generation unit which generates an intermediate file, which is called a display list, from interpreted PDL data. The rendering unit includes a color matching module (CMM) unit which performs color matching on the display list and a DL rasterization unit which rasterizes the display list into a bitmap (raster image).

The PDL interpretation unit analyzes various types of input PDL data. Examples of the input format include the well-known PostScript° language from Adobe and the printer control language (PCL) from Hewlett-Packard.

These languages are described in a printer control code for producing page unit images. The languages may be a simple character code, or alternatively a graphics drawing code or a photograph image code. Another format that is widely used in various industries is Adobe's portable document format (PDF), which employs a rasterized document display file format. This format, in which data is directly input into the MFP without using a driver, may also be used.

Further examples of formats that can be analyzed include Variable Data Print (VDP) formats, such as personalized print markup language (PPML), and color image compression formats, such as joint photographic experts group (JPEG) and tagged image file format (TIFF).

Various image data can be input by the CMM unit, such as gray scale, RGB, and CMYK. For other color spaces, the image data is converted into CMYK space by a color rendering dictionary (CRD), and then subjected to color matching. Color adjustment is performed by the CMM unit based on an international color consortium (ICC) profile. ICC profiles include a source profile and a printer profile.

The source profile is converted into an L*a*b* space in which the RGB (or CMYK) data has been normalized, and then this L*a*b* data is again converted into a CMYK space suited to the target printer. At this stage, the source profile is formed with an RGB profile and a CMYK profile.

If the input image is an RGB image (a Microsoft software application, or a JPEG or TIFF image etc.), the RGB profile is selected. If the input image is a CMYK based image (partial data from Adobe's Photoshop or Illustrator etc.), the CMYK profile is selected.

Next, the printer profile is created based on the color characteristics of each printer. For an RGB image, “perceptual” (tint priority) or “saturation” (vividness priority) may be desirably selected. For a CMYK based image, the optimum image can often be output by selecting “colorimetric” (color difference minimized). Further, the ICC profile is usually created based on a lookup table format.

In the source profile, when RGB (or CMYK) data is input, the RGB (or CMYK) data is converted uniquely into L*a*b* data. In contrast, in the printer profile, L*a*b* data is converted into CMYK data that matches the printer. RGB data that does not require color matching is converted into CMYK data based on a default color conversion, and then output. CMYK data that does not require color matching is output as is.

The image data rasterized by the RIP unit 108 is stored in the document management unit 111 via the compression/decompression unit 110 based on a control by the MFP control unit 106.

### <Output Image Processing Unit>

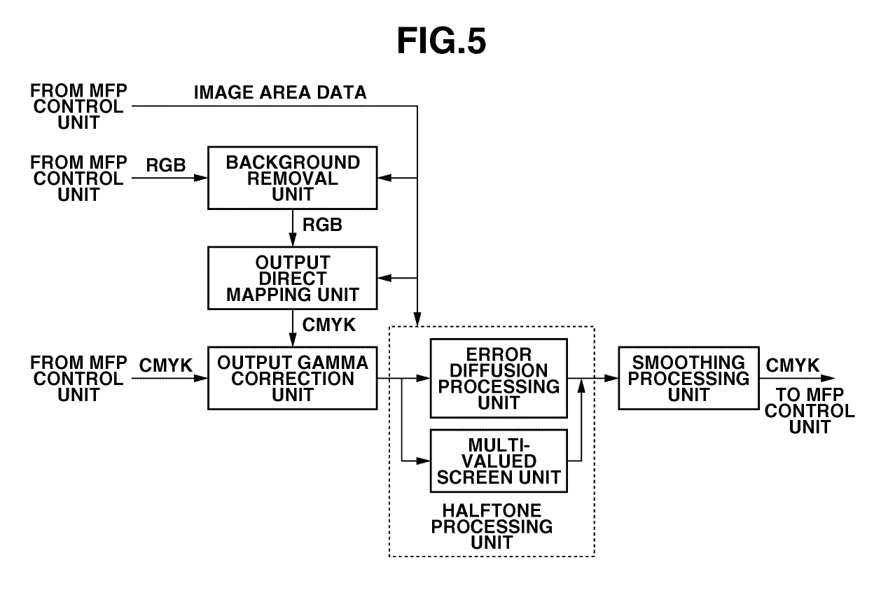

The output image processing unit 109 will now be described referring to FIG. 5, which is a block diagram of the output image processing unit 109. Broadly classified, the image data that is input into the output image processing unit 109 (color system) is either RGB data, which deals with output data from the compression/decompression unit 110 obtained by a copying operation or the like, or CMYK data, which deals with output data from the RIP unit 108 obtained by a network print operation or the like.

For RGB data, the data is input into a background removal unit. For CMYK data, the data is input into an output gamma correction unit. The background removal unit performs non-linear conversion on the RGB image data read by the scanner to remove a background portion.

Next, an output direct mapping unit converts the RGB image data into CMYK image data. During the conversion, the values for red, green, and blue are input into a lookup table, and a cyan (C) component is produced based on the sum total of the output values. The magenta (M), yellow (Y), and black (K) components are similarly formed by using the lookup table and the summation operation.

At this stage, based on the image area data detected by the input image processing unit 101, a three-dimensional lookup table is used to apply different types of lookup table to character areas and photograph areas.

The output gamma correction unit corrects the density of the output image based on the printer. Using a one-dimensional lookup table for cyan, magenta, yellow, and black, respectively, the output gamma correction unit has a function of maintaining the linearity of the output image data that differs for each formed imaged. Typically, the results of color calibration are reflected in the lookup table.

The half-tone processing unit can selectively apply different types of screening based on the MFP function. Generally, for a copying operation, error diffusion type screening in which moire does not easily occur is used. For a print operation, multi-valued screen type screening that employs a dither matrix in consideration of character and fine line reproducibility is often used.

In error diffusion type screening, correction is performed by weighting a target pixel and the surrounding pixels based on an error filter, and allocating gray-scale errors while maintaining the gradation number. On the other hand, in multi-valued screen type screening, a dither matrix threshold is set with multiple values, and the halftones are pseudo-expressed. The halftones are independently converted into CMYK, and reproduced by switching the low line numbers and the high line numbers based on the input image data.

Further, in multi-valued screen type screening, a smoothing processing unit can be used to lessen jaggies by detecting the edge portions corresponding to each of cyan, magenta, yellow, and black by pattern matching, and converting into a pattern that is more smoothly reproduced.

### <Operation Unit>

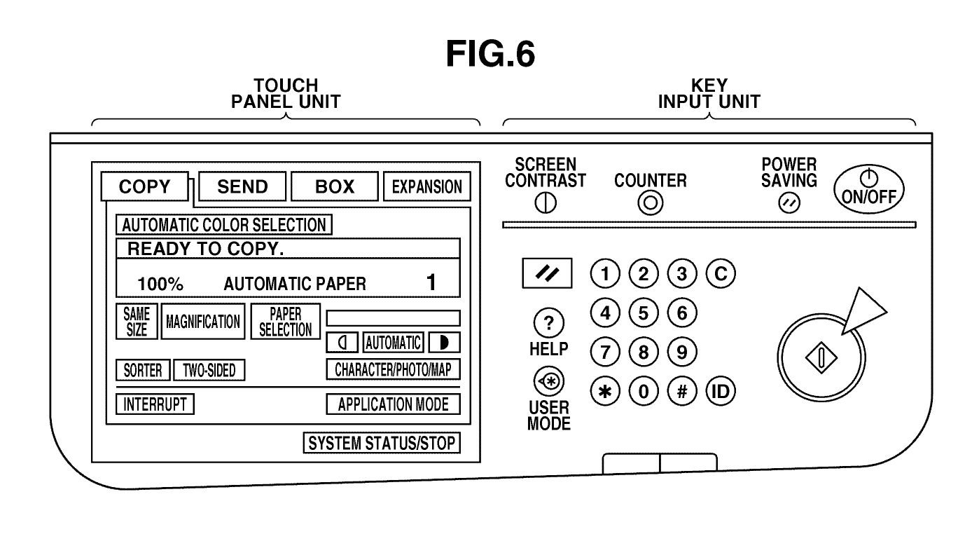

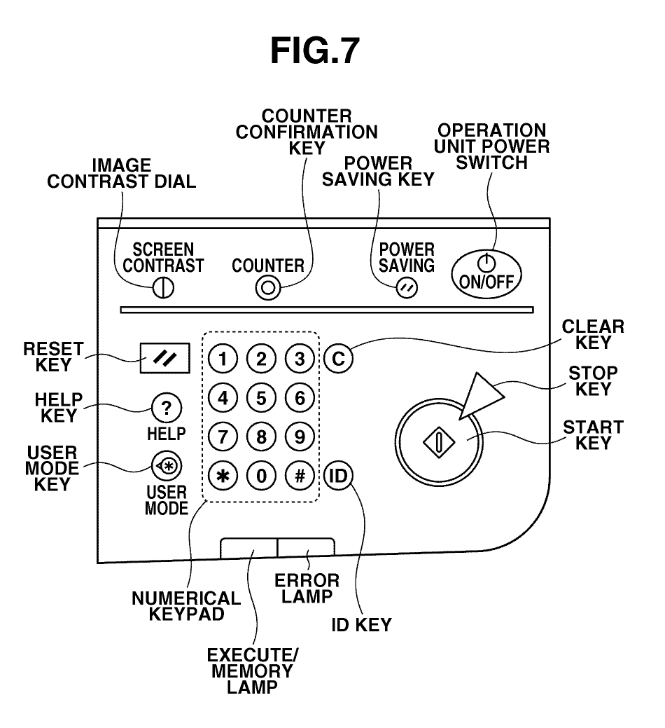

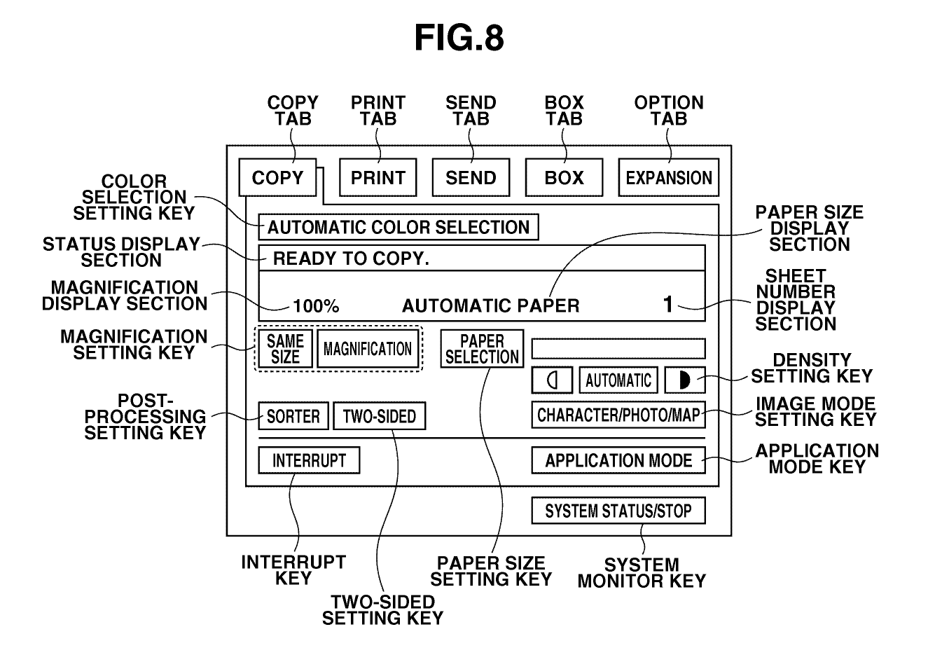

Next, the operation unit 107 will be described referring to FIG. 6, which is a schematic diagram of the operation unit 107. The operation unit 107 of the MFP 100 illustrated in FIG. 6 includes a key input unit and a touch panel unit, which are illustrated in more detail in FIGS. 7 and 8, respectively. These units will now be described in detail.

FIG. 7 is a schematic diagram of the key input unit, which enables the operator to set routine operations. An operation unit power switch is used to switch between a standby mode (normal operation state) and a sleep mode (mode in which, to suppress power consumption, the main controller stops a program in a state waiting for an interruption to come for network printing or a facsimile etc.). These modes can be controlled based on the ON state of the main power switch for supplying power to the whole system.

A power saving key is for suppressing power consumption by reducing the control temperature of the fixing device during standby mode. However, in a power saving state, it takes time to get the system ready for printing again. The control temperature can also be reduced based on a power saving ratio setting.

A start key is for instructing copying, sending and the like to start. A stop key is for stopping that process. A numerical keypad is for entering numbers for various settings. A clear key is for deleting that number entry. An ID key is for inputting a pre-set password for authentication of the MFP operator.

A reset key is for invalidating the settings and returning them to a default state. A help key is for displaying guidance and help. A user mode key is a key for moving to a system setting screen for each user.

A counter confirmation key is for displaying the number of output sheets that is stored in a software counter, which is provided in the MFP and counts the number of print copies. The number of output sheets can be displayed based on, for example, the operation mode such as copy/print/scan/facsimile, a color mode such as color/monochrome, and paper size such as large/small.

An image contrast dial is for making the screen easier to view by, for example, adjusting the backlight of a liquid crystal display in the touch panel unit. An execution/memory lamp blinks during job execution and when the memory is accessed. An error lamp notifies the operator of an error by blinking when a job cannot be executed, or when the apparatus needs to be repaired, or when the apparatus has jammed or run out of consumables.

FIG. 7 is a schematic diagram illustrating a touch panel display including a liquid crystal display (LCD) and transparent electrodes stuck thereon. The touch panel display is pre-programmed so that when a transparent electrode at a portion corresponding to a key displayed on the LCD is touched by a finger, it senses that touch and displays a different operation screen. FIG. 7 illustrates an initial screen during standby mode, which can display various operation screens based on the set operation.

A copy tab is for transiting to an operation screen for the copy operation. The send tab is for transiting to an operation screen for issuing a send operation, such as facsimile or E-mail sending. A box tab is for transiting to a screen for input/output operation of a job to a box (storage unit for storing jobs on a per-user basis).

An option tab is for setting an expansion function, such as a scanner setting. A system monitor key is for displaying the condition and status of the MFP. The touch panel display can transit to each operation mode by selecting the respective tabs.

A color selection setting key is for pre-selecting color coping, monochrome copying, or automatic selection. A magnification setting key is for transiting to a screen for setting magnification, such as same size, enlarge, or reduce. A post-processing key is for transiting to a screen for setting yes/no for stapling and punching, and the number and position of staples and/or punch holes.

A two-sided setting key is for transiting to a screen for selecting one-sided or two-sided printing. A paper size setting key is for transiting to a screen for selecting a sheet feed stage, paper size, and media type. An image mode setting key is for selecting the image mode that is suited to the original image, such as character mode or photograph mode. A density key is for increasing or reducing the density of the output image.

A status display section displays a simple status display indicating whether the MFP is on standby, warming up, jammed, or suffering from an error. A magnification display section displays the magnification set using the magnification setting key. A sheet size display section displays the paper size and mode set by the paper size setting key. A sheet number display section displays the number specified using the numeric keypad and the page number of the page currently being printed during the operation.

An interrupt key is used when interrupting a copy operation with a separate job. An application mode key is for transiting to a screen for setting various image processes and the layout, such as consecutive page copying, cover sheet/interleaf setting, reduced layout, and image movement.

### <Job Status Screen>

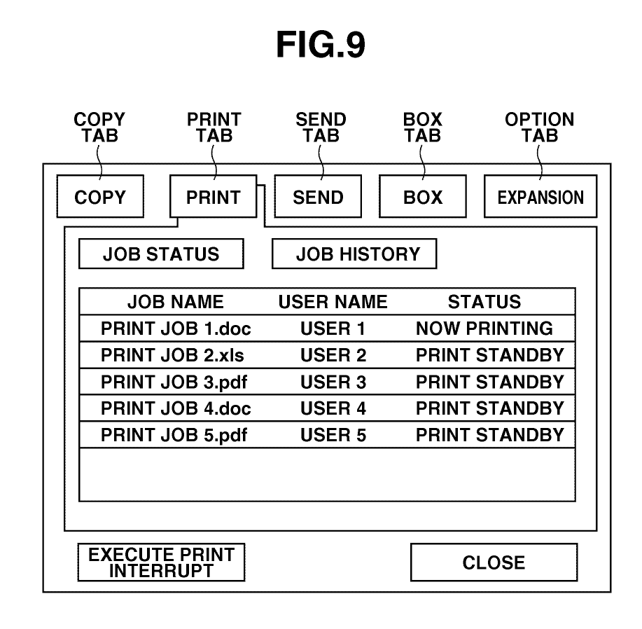

Next, the status screen of a print job (hereinafter, simply referred to as “job”) currently being printed or on print standby will be described. If the print tab on the touch panel illustrated in FIG. 8 is selected, the job status screen illustrated in FIG. 9 is displayed. This job status screen displays a list of the jobs currently being printed or on print standby, in which the job name, the user name, the status and the like are displayed for each job. In this example, “print job 4.doc” in the job list has a different background from the other jobs in the list, indicating that this job has been selected by the user.

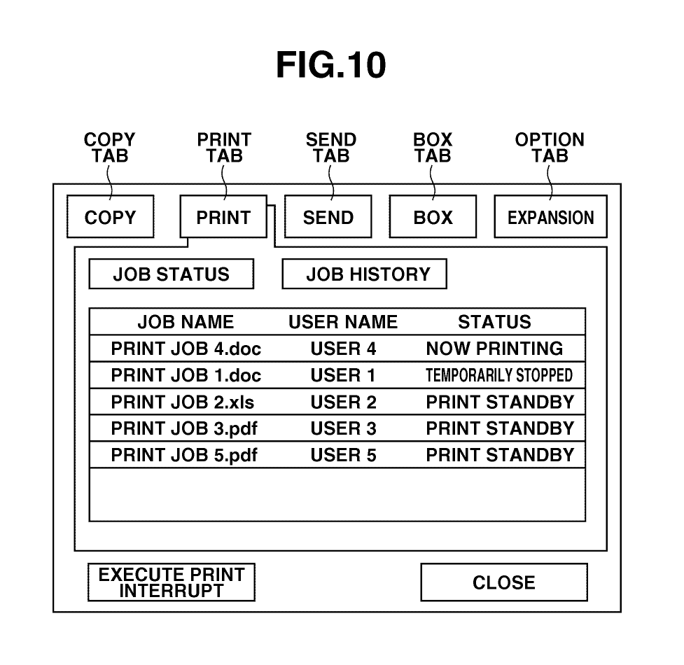

When the “execute interrupt printing” button arranged at the bottom of the screen is pressed for this selected job, as illustrated in FIG. 10, printing of the job “print job 1.doc” currently being printed is temporarily stopped (interrupted by “print job 4.doc”), and printing of “print job 4.doc” starts. When printing of “print job 4.doc” is completed, the temporarily-stopped “print job 1.doc” is restarted.

Control of the MFP 100 during job interrupt printing will now be described. When a job is input into the output job control unit 203, the setting information of the job is analyzed by the job analysis unit. The analyzed information is sent to the RIP unit 108 via the binder analysis unit, the document analysis unit, and the page analysis unit. The information is rasterized by the RIP unit 108. The rasterized image data is compressed by the compression/decompression unit 110, and stored in the document management unit 111. The document management unit 111 manages the print order based on the job priority level.

### <Conventional Interrupt Print Processing>

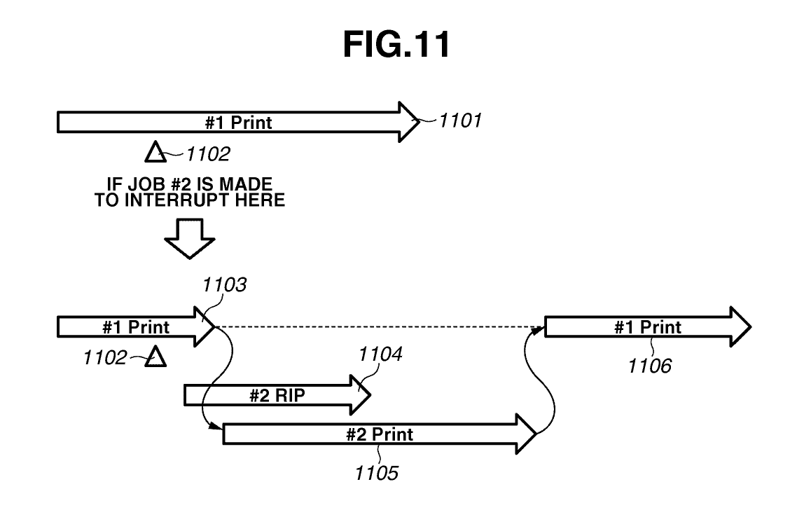

An outline of conventional interrupt print processing will now be described referring to FIG. 11. FIG. 11 illustrates the processing relationship between a job to be interrupted (hereinafter, interrupted job #1) and an interrupting job #2, with the horizontal direction from left to right used for the time axis. If the interrupted job #1 is processed without being interrupted, the interrupted job #1 is printed at the time indicated by the arrow 1101.

If an instruction to interrupt (interrupt printing instruction) job #1, which is currently being processed, with job #2 is issued at a timing indicated by the triangular mark 1102, the processing illustrated in the lower half of FIG. 11 is performed. First, RIP processing of job #2 is started as indicated by arrow 1104. Then, when the RIP processing of job #2 proceeds so that printing can be started, the printing of job #1 is stopped, and the printing of job #2 is started (arrow 1105). When the printing of job #2 is finished, the printing of the remaining portion of job #1 is restarted (arrow 1106).

### <Problems With Conventional Interrupt Print Processing>

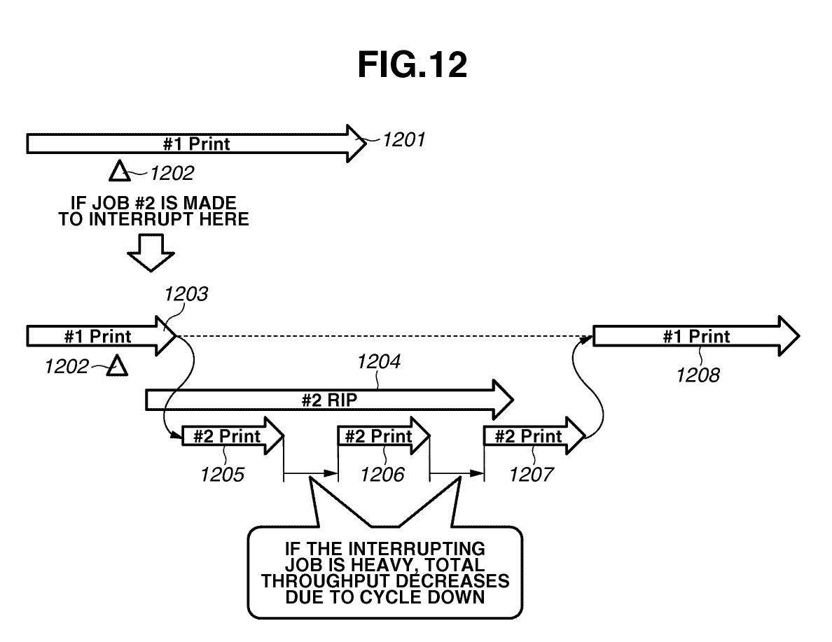

The problems with the conventional interrupt print processing illustrated in FIG. 11 will now be described referring to FIG. 12. Similar to FIG. 11, FIG. 12 illustrates the processing relationship between an interrupted job #1 and an interrupting job #2. If job #1 is processed without being interrupted, job #1 is printed at the time indicated by the arrow 1201.

If an instruction to interrupt job #1 with job #2 is issued at a timing indicated by the triangular mark 1202, the processing illustrated in the lower half of FIG. 12 is performed. First, the RIP processing of job #2 is started as indicated by arrow 1204. When the RIP processing of job #2 progresses so that printing can be started, the printing of job #1 is stopped, and the printing of job #2 is started (arrow 1205).

The difference between FIG. 11 and FIG. 12 is that in FIG. 12 the job #2 is a heavier job that takes a longer time to process, which means that the RIP processing time 1204 is longer. The speed of the printing performed by the printer unit 113 is, for example, 135 sheets per minute for A4 paper. For a job whose RIP processing cannot keep up with the printing speed of the printer unit 113, printing is temporarily stopped. Printing is restarted once the image data is generated by the RIP processing.

If printing is temporarily stopped, it takes time for the processing to stop (called “post-rotation”) and time to restart the printing at a stable printing speed (called “pre-rotation”). This is illustrated by reference numerals 1206 and 1207 in FIG. 12. Subsequently, when the printing of job #2 is finished, the remaining portion of the interrupted job #1 is printed (1208).

Thus, if the interrupting job #2 is a job that takes time for the RIP processing, since the printer unit 113 temporarily stops, the total printing throughput deteriorates. Especially, if printing is started in a state in which RIP processing has finished for all of the pages of the interrupted job #1, the interrupted job #1 can be consecutively printed without having to temporarily stop the printer unit 113.

Further, for most variable data print (VDP) jobs, the RIP processing time for each page can be reduced by performing the RIP processing of repeated images only once. Consequently, printing can be performed without having to temporarily stop the printer unit 113. In such a case, if the interrupting job #2 causes the printer unit 113 to temporarily stop, the overall printing productivity dramatically deteriorates.

### <Interrupt Print Processing Performed by the MFP According to the First Exemplary Embodiment>

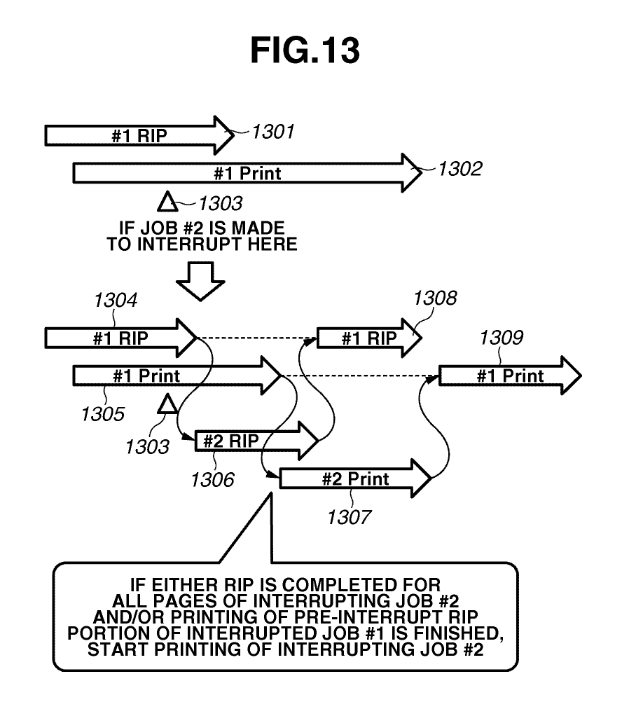

Next, the flow of the interrupt processing performed by the MFP 100 according to the present exemplary embodiment will be described referring to FIG. 13. Similar to FIG. 12, FIG. 13 illustrates the processing relationship between interrupted job #1 and interrupting job #2. If job #1 is processed without being interrupted, job #1 is subjected to RIP processing at the time indicated by arrow 1301, and printed at the time indicated by arrow 1302.

If an instruction to interrupt job #1 with job #2 is issued at a timing indicated by the triangular mark 1303, the processing illustrated in the lower half of FIG. 13 is performed. First, the RIP processing of job #1 is stopped as indicated by arrow 1304, and the RIP processing of job #2 is started as indicated by arrow 1306.

Then, when the RIP processing of job #2 progresses so that printing can be started, rather than immediately stopping the printing of job #1, the printing of job #1 is stopped when a condition is satisfied. This condition is either “RIP processing for all pages included in job #2 has finished” or “printing of pages included in job #1 for which RIP processing is completed has finished”. If either of these conditions is satisfied, the printing of job #1 is stopped (1305), and the printing of job #2 is started (1307).

When the RIP processing of job #2 (1306) is finished, the RIP processing of the remaining pages of job #1 for which ripping has not been completed is restarted (1308). Then, when the printing of job #2 is finished (1307), the printing of the remaining pages of job #1 is restarted (1309).

The difference between FIG. 13 and the conventional interrupt print processing illustrated in FIG. 12 is that in FIG. 13 the start of printing the interrupting job #2 is delayed based on a condition.

As described referring to FIG. 13, the printing of the interrupting job #2 is started after processing the RIP processing of the interrupting job #2 as much as possible. Consequently, the problem of the printing temporarily stopping due to the RIP processing not keeping up with the printing speed of the printer unit 113 as in FIG. 12 is avoided. As a result, the printing of job #2 is finished earlier, so that, including the restarted printing of the interrupted job #1, the overall printing time can be shortened.

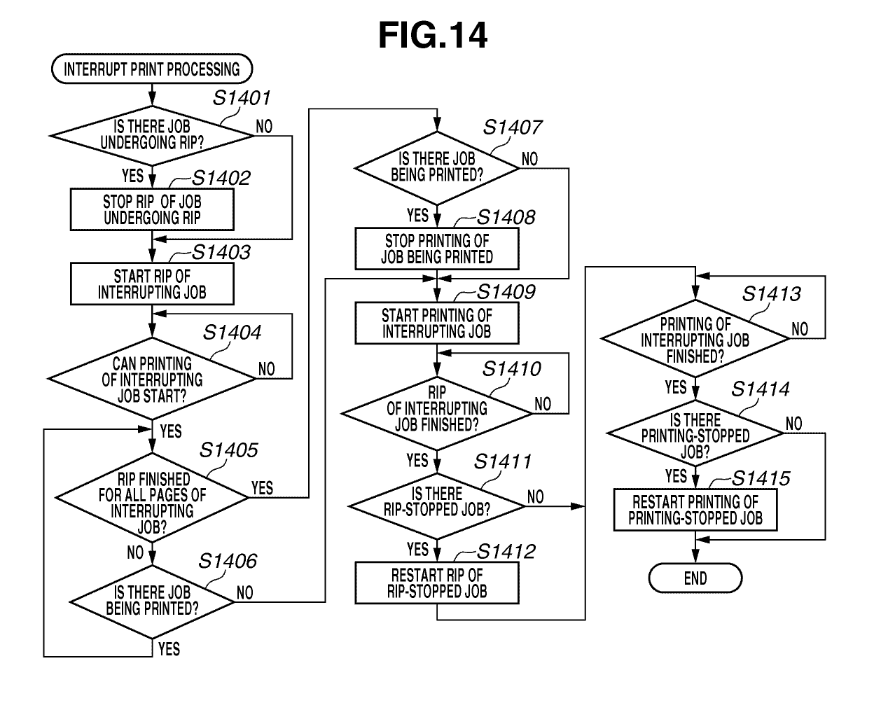

The flow illustrated in FIG. 13 of the interrupt print processing performed by the MFP 100 will now be described referring to a flowchart illustrated in FIG. 14. The processing illustrated in FIG. 14 is performed by the CPU in the MFP control unit 106 when an interrupt processing instruction is issued. Each of the processes in the flowchart illustrated in FIG. 14 is realized by the CPU in the MFP control unit 106 executing a program stored in the memory or on the hard disk of the MFP control unit 106.

Further, the flowchart illustrated in FIG. 14 illustrates processing that is performed after the user issues an instruction to execute interrupt printing on the operation unit 107 screens illustrated in FIGS. 9 and 10. Obviously, the instruction to execute interrupt printing is not limited to being issued from the operation unit 107, and may be issued from an external apparatus such as a client personal computer (PC) connected to the MFP 100 via a network, for example.

In step S1401, the MFP control unit 106 confirms whether there is a job undergoing RIP processing by the RIP unit 108. If it is determined that there is no job undergoing RIP processing (NO in step S1401), the processing proceeds to step S1403. On the other hand, if it is determined that there is a job undergoing RIP processing (YES in step S1401), the processing proceeds to step S1402.

In step S1402, the MFP control unit 106 stops the RIP processing of the job undergoing RIP processing, and the processing proceeds to step S1403. In step S1403, the MFP control unit 106 controls the RIP unit 108 so that RIP processing of the interrupting job is started.

In step S1404, the MFP control unit 106 determines whether printing of the interrupting job can be started. Although the timing for determining that printing can start depends on the interrupting job condition, for example, if the interrupting job is one-sided normal printing, the MFP control unit 106 determines that printing can start when the RIP processing of the first page is finished. If it is determined that printing can start (YES in step S1404), the processing proceeds to step S1405. If it is not determined that printing can start (NO in step S1404), the determination processing performed in step S1404 is continued.

In step S1405, the MFP control unit 106 determines whether RIP processing for all pages of the interrupting job is finished. If it is determined that RIP processing for all pages is finished (YES in step S1405), the processing proceeds to step S1407. If it is determined that RIP processing for all pages is not finished (NO in step S1405), the processing proceeds to step S1406.

In step S1406, the MFP control unit 106 determines whether there is a job currently being printed by the printer unit 113. If it is determined that there is a job currently being printed (YES in step S1406), the processing returns to step S1405. If it is determined that there is no job currently being printed (NO in step S1406), the processing proceeds to step S1409. The determination performed in this step is performed when the RIP processing of the interrupting job has not been completed for all of the pages, and is thus processing performed to print as much of the interrupting job as possible during the RIP processing of the interrupting job.

In step S1407, the MFP control unit 106 determines whether there is a job currently being printed by the printer unit 113. If it is determined that there is a job currently being printed (YES in step S1407), the processing proceeds to step S1408. If it is determined that there is no job currently being printed (NO in step S1406), the processing proceeds to step S1409. The determination performed in this step is performed when RIP processing of the interrupting job has been completed for all of the pages, and is thus processing performed to confirm whether there is a job currently being printed that should be stopped before starting the printing of the interrupting job.

In step S1408, the MFP control unit 106 controls the printer unit 113 so as to stop printing of the job being printed. In step S1409, the MFP control unit 106 controls the printer unit 113 so as to start printing of the interrupting job.

In step S1410, the MFP control unit 106 determines whether the RIP processing by the RIP unit 108 of the interrupting job is finished for all pages. If it is determined that the RIP processing of the interrupting job is not finished (NO in step S1410), the determination processing of step S1410 is continued. If it is determined that the RIP processing of the interrupting job is finished (YES in step S1410), the processing proceeds to step S1411.

In step S1411, the MFP control unit 106 determines whether there is a job for which the RIP processing has been stopped. If it is determined that there is a job for which the RIP processing has been stopped (YES in step S1411), the processing proceeds to step S1412. If it is determined that there is no job for which RIP processing has been stopped (NO in step S1411), the processing proceeds to step S1413.

In step S1412, the MFP control unit 106 controls the RIP unit 108 so as to restart the RIP processing of the job for which the RIP processing was stopped. In step S1413, the MFP control unit 106 determines whether the printing of all the pages included in the interrupting job has finished. If it is determined that the printing of all the pages included in the interrupting job has finished (YES in step S1413), the processing proceeds to step S1414. If it is determined that the printing of all the pages included in the interrupting job has not finished (NO in step S1413), the determination processing of step S1413 is continued.

In step S1414, the MFP control unit 106 determines whether there is a job for which printing has been stopped. If it is determined that there is a job for which printing has been stopped (YES in step S1414), the processing proceeds to step S1415. If it is determined that there are no jobs for which printing has been stopped (NO in step S1414), the interrupt processing is finished.

In step S1415, the MFP control unit 106 controls the printer unit 113 so as to restart the printing of the job for which printing has been stopped, and finishes the interrupt processing.

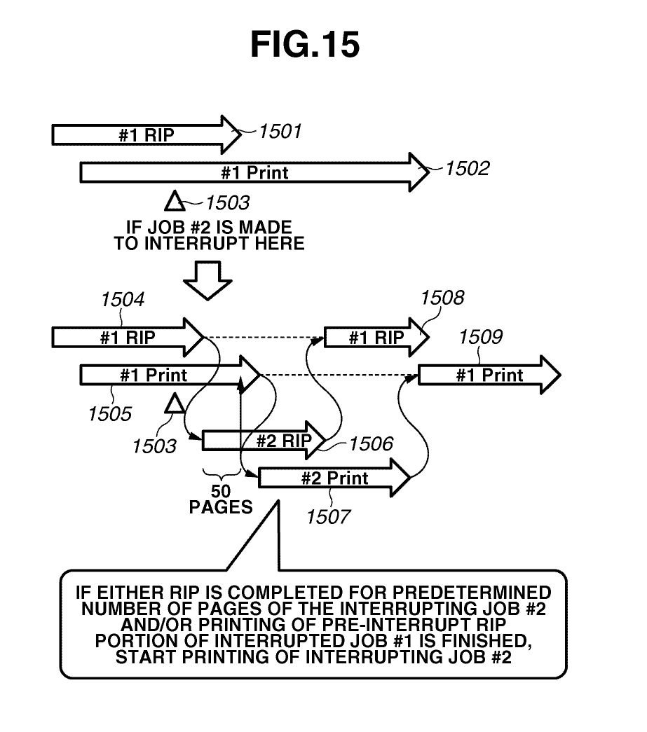

Thus, in the present exemplary embodiment, at arrow 1504 (refer to FIG. 15), even if it is determined that printing of the interrupting job can start, the printing of the interrupting job is not immediately started. Rather, the printing of the interrupting job is started only after waiting for a condition to be satisfied at arrows 1505 and 1506. Consequently, the problem of the printing temporarily stopping due to the RIP processing not keeping up with the printing speed of the printer unit 113 can be prevented. As a result, the printing of the interrupting job is finished earlier, so that, including the restarted printing of the interrupted job, the overall printing time can be shortened.

In the first exemplary embodiment, printing of the interrupting job is started when the RIP processing of all the pages included in the interrupting job has finished, or when the printing of the pages included in the interrupted job for which RIP processing is completed has finished. In the present exemplary embodiment, processing will be described in which “when the RIP processing of a predetermined number of pages or more among the pages included in the interrupting job has finished” is added as a condition for starting the printing of the interrupting job.

Since the MFP applied in the present exemplary embodiment is similar to that used in the first exemplary embodiment, a description thereof will be omitted here. Further, the description of the processing referring to the flowchart will only be described for those parts that are different from the first exemplary embodiment.

### <Interrupt Print Processing Performed by the MFP 100 According to the Second Exemplary Embodiment>

Next, the flow of the interrupt processing performed by the MFP 100 according to present exemplary embodiment will be described referring to FIG. 15. Similar to FIG. 13, FIG. 15 illustrates the processing relationship between interrupted job #1 and interrupting job #2. If job #1 is processed without being interrupted, job #1 is subjected to RIP processing at the time indicated by arrow 1501, and printed at the time indicated by arrow 1502.

If an instruction to interrupt job #1 with job #2 is issued at a timing indicated by the triangular mark 1503, the processing illustrated in the lower half of FIG. 15 is performed. First, the RIP processing of job #1 is stopped as indicated by arrow 1504, and the RIP processing of job #2 is started as indicated by arrow 1506.

Then, when the RIP processing of job #2 progresses so that printing can be started, rather than immediately stopping the printing of job #1, the printing of job #1 is stopped when a condition is satisfied. This condition is either “RIP processing for all or a predetermined number or more of the pages included in job #2 has finished” or “printing of pages included in job #1 for which RIP processing is completed has finished”.

If either of these conditions is satisfied, the printing of job #1 is stopped (1505), and the printing of job #2 is started (1507). Although the predetermined number of pages in the example illustrated in FIG. 15 is 50 pages, the optimum number may be some other value depending on, for example, the printing speed of the printer unit 113. This number can be appropriately changed based on the setting. Further, the optimum number of pages may also be automatically determined based on job information, such as the job page number and the processing time taken for the RIP processing.

When the RIP processing of job #2 (1506) is finished, the RIP processing of the remaining pages of job #1 for which the ripping has not been completed is restarted (1508). Then, when the printing of job #2 is finished (1507), the printing of the remaining pages of job #1 is restarted (1509).

The difference between FIG. 15 and the interrupt print processing according to the first exemplary embodiment illustrated in FIG. 13 is the addition of “when the RIP processing of a predetermined number of pages or more included in the interrupting job #2 has finished” as a condition for starting the printing of the interrupting job #2. Consequently, especially when the number of pages in the interrupting job #2 is large, the problem of an unnecessary delay in the start of the printing of the interrupting job #2 even though the operator wishes to prioritize the interrupting job #2, can be prevented.

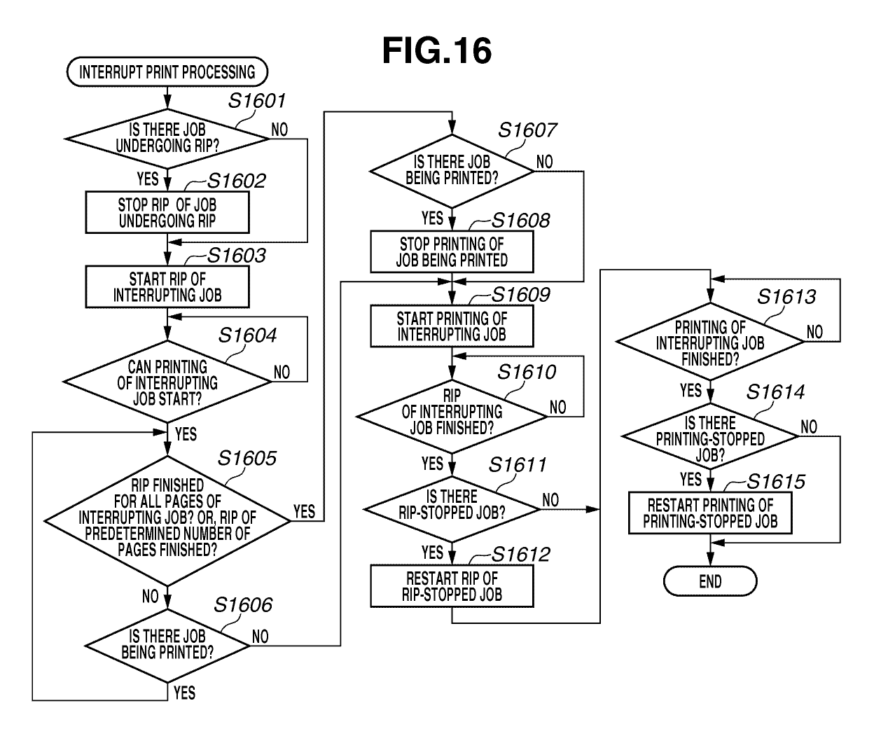

The flow illustrated in FIG. 15 of the interrupt print processing performed by the MFP 100 will now be described referring to the flowchart illustrated in FIG. 16. The processing illustrated in FIG. 16 is performed by the CPU in the MFP control unit 106 when an interrupt processing instruction is issued. Each of the processes in the flowchart illustrated in FIG. 16 is realized by the CPU in the MFP control unit 106 executing a program stored in the memory or on the hard disk of the MFP control unit 106.

Further, the flowchart illustrated in FIG. 16 illustrates processing that is performed after the user issues an instruction to execute interrupt printing on the operation unit 107 screens illustrated in FIGS. 9 and 10. Obviously, the instruction to execute interrupt printing is not limited to being issued from the operation unit 107, and may be issued from an external apparatus such as a client personal computer (PC) connected to the MFP 100 via a network, for example.

Since the processing performed in steps S1601 to 1604 and steps S1606 to S1615 in the flowchart illustrated in FIG. 16 is the same as that of steps S1401 to S1404 and steps S1406 to S1415 in the flowchart illustrated in FIG. 14, a description of these steps will be omitted. Only the processing of step S1605 will be described.

In step S1605, the MFP control unit 106 determines whether the RIP processing for all or a predetermined number or more of the pages of the interrupting job has finished. If it is determined that the RIP processing for all or a predetermined number or more of the pages of the interrupting job has finished (YES in step S1605), the processing proceeds to step S1607. If the RIP processing for all or a predetermined number or more of the pages of the interrupting job has not finished (NO in step S1605), the processing proceeds to step S1606.

Thus, in the interrupt processing according to the present exemplary embodiment, printing of the interrupting job is started when the RIP processing of a predetermined number or more pages has finished, without waiting for the RIP processing of all of the pages of the interrupting job having finished. Consequently, an unnecessary delay in the first print out time (FPOT) of the interrupting job can be prevented.

However, if there is a page that will take time for RIP processing after the predetermined number of pages, cycle down may occur during printing of the interrupting job. Therefore, depending on the job, there is a slight chance that the interrupt print processing of the first exemplary embodiment is more preferable. Consequently, the system may be configured so that the number of predetermined pages can be set, and when that setting is “zero pages”, the MFP control unit 106 performs similar interrupt print processing as the first exemplary embodiment.

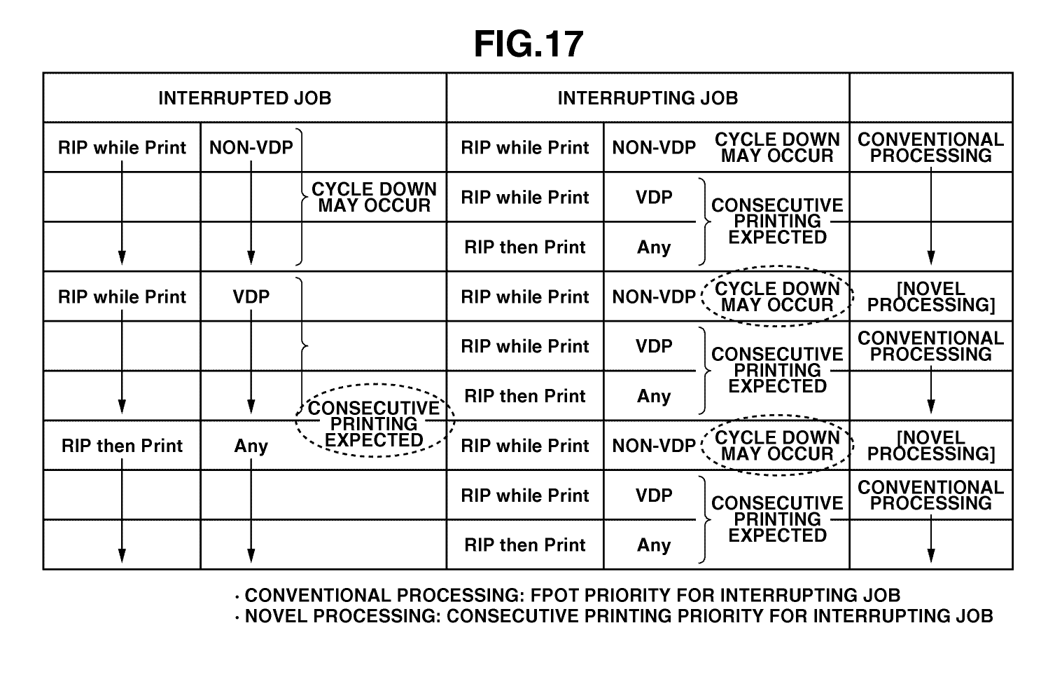

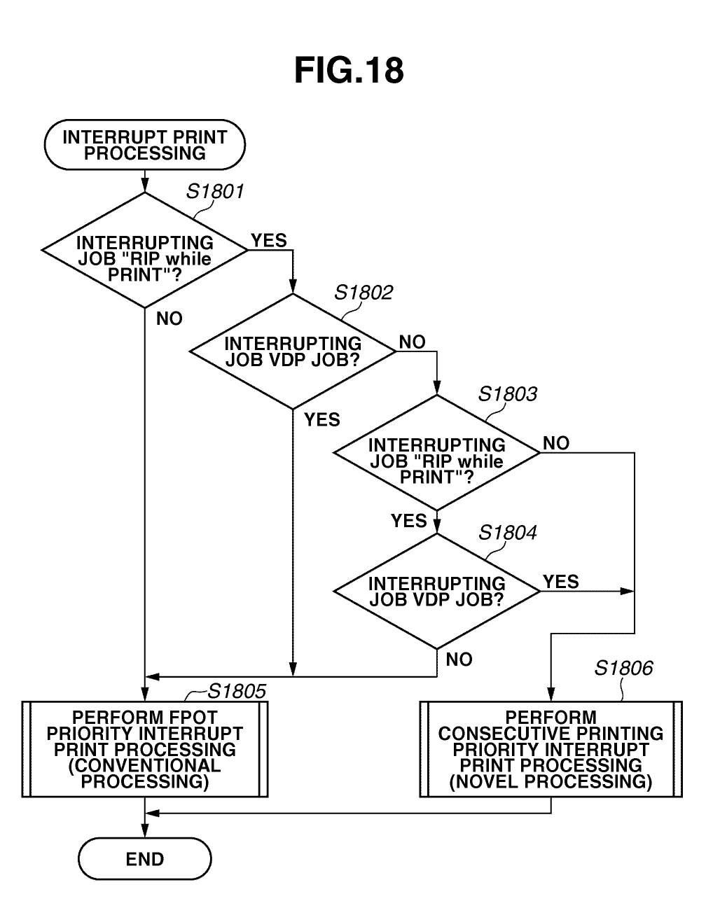

Another exemplary embodiment will now be described referring to FIGS. 17 and 18. In this exemplary embodiment, the control method of the interrupt print processing is switched based on the type of the interrupted job and of the interrupting job.

In the present exemplary embodiment, examples of the MFP control unit 106 setting include “RIP while Print” and “RIP then Print”. This setting can be changed by the administrator via the operation unit 107. RIP while Print is the default setting. In the RIP while Print setting, in FIG. 2, the print job is sent to the printer unit 113 via the output apparatus management unit 204 as the necessary pages are stored in the document management unit 111, without waiting for the last page to be stored in the document management unit 111.

On the other hand, in RIP then Print, the print job is sent to the printer unit 113 via the output apparatus management unit 204 once the last page has been stored in the document management unit 111. Further, even if the MFP control unit 106 setting is RIP while Print, the printing can optionally be performed by performing only RIP processing on the job, storing the resultant data as a rasterized job in the document management unit 111 without printing it, and printing at a later time.

In this case, the job is considered to be a RIP then Print job. RIP while Print jobs have the merit that the first page is printed the fastest by the printer unit 113. More specifically, RIP while Print jobs have the shortest First Print Output Time (FPOT).

However, if there is a page midway through the job that will take time for RIP processing, the RIP processing may not keep up with the printing speed of the printer unit 113, causing cycle down to occur. Consequently, the printing throughput may deteriorate. On the other hand, for RIP then Print jobs, since the printing only starts after the RIP processing of the last page has finished, cycle down due to the RIP processing not keeping up with the printing speed does not occur, so that the printing speed of the printer unit 113 can be fully utilized. However, the FPOT increases.

Thus, a RIP while Print job is a job in which print processing is started before the RIP processing of all the pages included in the job has finished. A RIP then Print job is a job in which print processing is started after the RIP processing of all the pages included in the job has finished.

Further, in the present exemplary embodiment, the print job has a job attribute indicating whether it is a VDP job or a non-VDP job. If the job is described in PPML, VPS, PDF/VT or the like, which are description languages for VDP, the job is viewed as a VDP job. If the job is not described in such a language, the job is viewed as a non-VDP job (i.e., is not a variable print job).

The RIP processing time for VDP jobs can generally be shortened by performing the RIP processing once on an image such as a background image that is reused again in the page, and reusing the resultant information from the second time onwards. Consequently, consecutive printing can be expected, as cycle down is unlikely to occur during printing even for RIP while Print.

FIG. 17 is a correspondence table illustrating the optimum interrupt print processing that is performed based on the attributes of the interrupted job and the interrupting job. First, if the interrupted job is RIP while Print and non-VDP, the interrupted job is a job in which cycle down might occur.

In this case, the MFP control unit 106 performs control so that the conventional FPOT priority processing is performed even for the interrupting job, and if cycle down occurs, determines that the cycle down was unavoidable (second control).

The conventional processing that is performed here is the interrupt print processing illustrated in FIG. 11. If the interrupted job is VDP or RIP then Print, consecutive printing can be expected. The system is configured so that, as far as possible, a job that is interrupted during printing with a job for which consecutive printing can be expected does not cause cycle down to occur, so that the total printing throughput does not decrease.

More specifically, since consecutive printing can be expected when the interrupting job is VDP or RIP then Print, the MFP control unit 106 performs control so that the FPOT priority conventional processing is performed (second control). Since cycle down can occur if the interrupting job #2 is RIP while Print and non-VDP, the MFP control unit 106 performs control so that the novel processing is performed (first control). This “novel processing” is the consecutive printing priority interrupt print processing illustrated in FIG. 16.

FIG. 18 illustrates the processing performed by the MFP control unit 106 when an interrupt processing instruction is issued. In step S1801, the MFP control unit 106 checks whether the interrupting job is an RIP while Print job. If the interrupting job is not an RIP while Print job (NO in step S1801), in step S1805, the MFP control unit 106 performs control so that FPOT priority interrupt print processing (conventional processing) is performed.

This FPOT priority interrupt print processing (conventional processing) is the interrupt print processing illustrated in FIG. 12. If the interrupting job is an RIP while Print job (YES in step S1801), in step S1802, the MFP control unit 106 checks whether the interrupting job is a VDP job. If the interrupting job is a VDP job (YES in step S1802), in step S1805, the MFP control unit 106 performs FPOT priority interrupt print processing (conventional processing).

If the interrupting job is not a VDP job (NO in step S1802), in step S1803, the MFP control unit 106 checks whether the interrupted job is a RIP while Print job. If the interrupted job is not a RIP while Print job (NO in step S1803), the processing proceeds to step S1806. In step S1806, the MFP control unit 106 performs consecutive printing priority interrupt print processing (novel processing). More specifically, the MFP control unit 106 performs the interrupt print processing illustrated in FIG. 17.

If the interrupted job is a RIP while Print job (YES in step S1803), in step S1804, the MFP control unit 106 checks whether the interrupted job is a VDP job. If the interrupted job is a VDP job (YES in step S1804), the MFP control unit 106 performs consecutive printing priority interrupt print processing (novel processing). If the interrupted job is not a VDP job (NO in step S1804), in step S1805, the MFP control unit 106 performs FPOT priority interrupt print processing (conventional processing).

Thus, by optimally controlling the printing start timing of the interrupting job based on the type and status of the interrupted job and the interrupting job, consecutive printing can be maintained without simply delaying the printing start of the interrupting job more than is necessary. Consequently, the overall printing throughput can be improved.

Although each of the exemplary embodiments according to the present invention is described using specific examples, the present invention is not limited to the above-described exemplary embodiments.

Further, the present invention can also be realized by supplying software (a program) for realizing the functions of the above exemplary embodiments to a system or an apparatus via a network or via various storage media, and having a computer (or a CPU or a micro processing unit (MPU)) of the system or apparatus read and execute the program. In this case, this program and the recording medium on which the program is recorded constitute the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-148203 filed Jun. 29, 2010, which is hereby incorporated by reference herein in its entirety.

What is claimed is:

1. An image forming apparatus to execute, during processing of a job to be interrupted that is currently being processed, interrupt print processing for starting processing on an interrupting job for which an interrupt instruction is issued based on an interrupt printing instruction, the image forming apparatus comprising:
a generation unit configured to generate image data by performing RIP processing on a print job including at least one page;
a printing unit configured to perform print processing based on image data generated by the generation unit; and
a control unit configured to, when the RIP processing of the pages included in the interrupting job by the generation unit is finished, control the printing unit so as to stop the print processing on the job to be interrupted and start print processing of the interrupting job.

2. The image forming apparatus according to claim 1, wherein the control unit is configured to, even when the RIP processing of the pages included in the interrupting job by the generation unit is not finished, control the printing unit so as to stop the print processing on the job to be interrupted and start print processing of the interrupting job when the print processing of a page for which RIP processing by the generation unit has finished among the pages included in the job to be interrupted is finished.

3. An image forming apparatus to execute, during processing of a job to be interrupted that is currently being processed, interrupt print processing for starting processing on an interrupting job for which an interrupt instruction is issued based on an interrupt printing instruction, the image forming apparatus comprising:
a generation unit configured to generate image data by performing RIP processing on a print job including at least one page;
a printing unit configured to perform print processing based on image data generated by the generation unit; and
a control unit configured to, when the RIP processing of a predetermined number of pages or more among the pages included in the interrupting job by the generation unit is finished, control the printing unit so as to stop the print processing on the job to be interrupted and start print processing of the interrupting job.

4. The image forming apparatus according to claim 3, wherein the control unit is configured to, even when the RIP processing of the predetermined number of pages or more among the pages included in the interrupting job by the generation unit is not finished, control the printing unit so as to stop the print processing on the job to be interrupted and start print processing of the interrupting job when the print processing of a page for which RIP processing by the generation unit has finished among the pages included in the job to be interrupted is finished.

5. The image forming apparatus according to claim 3, wherein the control unit is configured to, based on a job type, switch between a first control which controls the control unit so as to stop the print processing on the job to be interrupted and start print processing of the interrupting job when the RIP processing of the predetermined number of pages or more among the pages included in the interrupting job by the generation unit has finished, and a second control which controls the control unit so as to stop the print processing on the job to be interrupted and start print processing of the interrupting job when print processing on the interrupting job can be executed.

6. The image forming apparatus according to claim 5, wherein the control unit is configured to switch the control in the interrupt print processing to the second control when the interrupting job type is a job for which print processing is started after RIP processing of all pages included in the job has finished or is a variable print job.

7. The image forming apparatus according to claim 5, wherein the control unit is configured to switch the control in the interrupt print processing to the first control when the interrupting job type is not a job for which print processing is started after RIP processing of all pages included in the job has finished or is not a variable print job, and the job type of the job to be interrupted is a job for which print processing is started after RIP processing of all pages included in the job has finished or is a variable print job.

8. A method for controlling an image forming apparatus to execute, during processing of a job to be interrupted that is currently being processed, interrupt print processing for starting processing on an interrupting job for which an interrupt instruction is issued based on an interrupt printing instruction, the method comprising:
generating image data by performing RIP processing on a print job including at least one page; and
performing print processing based on the image data
stopping the print processing on the job to be interrupted, and starting print processing on the interrupting job, when the RIP processing of a predetermined number of pages or more among the pages included in the interrupting job is finished.

9. The method for controlling an image forming apparatus according to claim 8, further comprising:
stopping the print processing on the job to be interrupted, and starting print processing of the interrupting job, even when the RIP processing of the predetermined number of pages or more among the pages included in the interrupting job is not finished, when the print processing of a page for which RIP processing has finished among the pages included in the job to be interrupted is finished.

10. The method for controlling an image forming apparatus according to claim 8, further comprising:
switching between a first method, which stops the print processing on the job to be interrupted and starts print processing of the interrupting job when the RIP processing of the predetermined number of pages or more among the pages included in the interrupting job has finished, and a second method, which stops the print processing on the job to be interrupted and starts print processing of the interrupting job when print processing on the interrupting job can be executed.

11. The method for controlling an image forming apparatus according to claim 10, further comprising:
switching the printing method to the second method when the interrupting job type is a job for which print processing is started after RIP processing of all pages included in the job has finished or is a variable print job.

12. The method for controlling an image forming apparatus according to claim 10, further comprising:
switching the printing method to the first method when the interrupting job type is a not job for which print processing is started after RIP processing of all pages included in the job has finished or is not a variable print job, and the interrupting job type is a job for which print processing is started after RIP processing of all pages included in the job has finished or is a variable print job.

13. A non-transitory computer-readable storage medium in which a program is stored that enables the method for controlling an image forming apparatus according to claim 8 to be executed.
